(19) United States
(12) Patent Application Publication
(10) Pub. No.: US 2012/0320510 A1
(43) Pub. Date: Dec. 20, 2012

(54) Mobile networked optimized supply, data, and power generation & distribution system

(75) Inventors: Kenneth Varga, Peoria, AZ (US); John Hiett, Tempe, AZ (US)

(73) Assignee: Real Time Company

(21) Appl. No.: 13/385,037

(22) Filed: Jan. 30, 2012

Related U.S. Application Data
(60) Provisional application No. 61/571,113, filed on Jun. 20, 2011.

(51) Int. Cl. G06F 1/16

(52) U.S. Cl. 361/679.03

(57) ABSTRACT

A mobile, networked, optimized, supply, power, generation, and distribution system that includes a light weight vest or suite that contains a highly reliable, standard, efficient, power and data storage system. The system provides modular standardized and adaptive means of efficiently powering, controlling, and monitoring the health and supply of one or more standardized portable load and data devices. Supplying and re-supplying is achieved through standardized modular means. Reliability and efficiency is achieved through sensing, redundant switching, and controlling fully protective efficient utilization of energy storage weight and standardized device load circuits.

### BACKGROUND OF THE INVENTION

### Prior Portable Power Distribution Vest Systems

Excess weight from unused batteries and other supplies has become a critical problem in mobility of a person carrying a large number of electronics and other materials over great distances. Having to move quickly and easily, while having to wear and/or carry all the material for extended periods has proven to be a burden for field personnel. This problem has become further exasperated by having many different battery types and many different power requirements.

As described in the article “Researchers Tackle Marines' Portable Power Challenges”, May 2011, National Defense, NDIA's Business and Technology Magazine, by Grace V. Jean, a key problem is needing to carry batteries for each specialized device, but not being able to use all of the batteries for other specialized devices because the batteries for the other devices are not the same. This introduces two problems: if a device uses up all the batteries of one type a user has in possession and other incompatible batteries cannot be used, then these unused batteries not only become excess weight, but also become unutilized energy sources due to carrying incompatible batteries.

The modern soldier, police officer, or firefighter, carrying heterogeneous electronics and other safety/warfare equipment with different power supply needs faces unnecessary challenges of this excess weight of batteries. Incompatible battery equipment, having to carry excess unused spare batteries and chargers after completing a mission all exemplifies the critical need to have a clear ideal standard for a highly reliable, light-weight, wearable, optimized power distribution and charging system. Many different battery types are currently being used instead of having one standard type. Only a small standard set of power parameters is all that is needed so that the system can utilize the maximum energy density per unit of mass the user carries. End device loads can adjust the voltage to fit their specialized application through converters or pin setting.

Most efficient light weight portable power distribution systems are designed for avionic, spacecraft, ships, automobiles, or other vessels through many years of quality engineering effort in weight efficiency; however none of these have been known to be effectively applied to a wearable vest.

### U.S. Patents

| Patent Number | Kind Code | Issue Date | Patentee |
|---|---|---|---|
| 7,872,444 | B2 | 2011 Jan. 18 | Symbol Technologies, |
| | | | Inc. |
| 7,863,859 | — | 2011 Jan. 04 | Cynetic Designs Ltd. |
| 7,411,337 | — | 2008 Aug. 12 | Intel Corporation |
| 7,221,552 | B1 | 2007 May 22 | Brown |
| 7,150,938 | — | 2006 Dec. 19 | Munshi |
| 6,915,641 | — | 2006 Dec. 19 | Lithium Power |
| | | | Technologies, Inc. |
| 6,899,539 | — | 2005 May 31 | Exponent Inc. |
| 5,806,740 | — | 1998 Sep. 15 | Raytheon Company |
| 5,572,401 | — | 1996 Nov. 05 | Key Idea Development, |
| | | | L.L.C. |

### U.S. Patent Application Publications

| Application Number | Kind Code | File Date | Patentee |
|---|---|---|---|
| 20110089894 | A1 | 2011 Apr. 21 | Soar; Roger J. |
| 20110018498 | A1 | 2011 Jan. 27 | Soar; Roger J. |
| 20110031928 | A1 | 2010 Oct. 13 | Soar; Roger J. |
| 20110018498 | A1 | 2010 Sep. 29 | Soar; Roger J. |

### FOREIGN PATENT DOCUMENTS

### Nonpatent Literature Documents

“Researchers Tackle Marines' Portable Power Challenges”; May 2011; Jean, Grace V.; National Defense: NDIA's Business and Technology Magazine

### SUMMARY OF THE INVENTION

A network of standard intelligent interconnected modules whereby health of the module, as well as the supply status of the module is monitored and communicated. The health monitoring data is used to allocate and share flows of critical supplies to and from modules in need, based on module criticality, and to provide supply flows in a prioritized manner.

The intelligent networked module includes an improved light weight wearable vest or suite (referred to as vest) that contains a standardized, highly reliable as well as interchangeable switchable mesh of supply, data distribution, & supplying systems that are integrated into a comfortable and light weight system such that if portions are destroyed by gunfire, explosives or other failures do not easily take down the entire system or critical elements within the system.

The improved vest modular system provides maximum utilization and reliability per unit weight of supply storage by automatically disconnecting and bypassing failed system modules, as well as automatically recovering system modules. System modules are standardized and prioritized such that they easily are added and removed with automatic configuration and recognition with manual override capability. All the supply sources and supply storage is standardized such that all supplies and supply sources contribute to the supplying of all functional modules with priority set on criticality level of modules, similar to that designed for criticality levels of avionics systems (e.g. Level A most critical, Level B critical, Level C less critical, Level D non-critical, and Level E least critical system).

Different common standardized voltage levels can be achieved on the same pin using Direct Current (DC) to DC converters. The different voltages can be provided on the same standard plug by setting different pin configurations such as shorting a pin or pins to a common ground thereby changing the pin voltage levels to established set standard levels.

For military or other applications, to improve energy efficiency per unit of mass carried the weight of bullet heads can be used for dual purpose as both projectiles as well as a battery that can be designed to survive bodily impact intact.

Energy recovery systems, such as a weapon re-coil energy recovery system as well as other energy recovery systems, such as from walking, running, wind, solar, or remote laser charging systems, can also be used to re-charge batteries as well as to power loads.

### Advantages

The primary advantage is a supply standard is established such that heterogeneous types of equipment modules can become standardized and thus can connect, communicate, and interact with each other seamlessly and immediately by optimizing and prioritizing shared supply consumption as well as tracking shared supply levels, health, and shared supply flows. Ultimately reducing the total supply mass required to be carried by mobile units.

Another advantage is to be able to optimize sensing and monitoring of remote health, as well as optimize prioritized distribution of supplies to mobile field personnel modules.

A further advantage is to be able to route and network health data, even where communications abilities are sparse or limited. Other advantages are dual use of material as energy storage, energy generation, along with original function.

### BRIEF DESCRIPTION OF THE FIGURES

FIG. 1 depicts a light weight wearable vest with wireless standard supply cell pockets and multiple quadrants where one quadrant is shown with standardized wired supply cells and an optional standardized connector is shown.

FIG. 2 shows a block diagram of a standardized intelligent supply module cell as well as how all the standardized intelligent supply module cells are interconnected within the vest.

FIG. 3 shows a high level control algorithm that runs on all of the standard intelligent device module cell controllers.

FIG. 4 shows interconnectivity between intelligent modular cells as well as their connection to a larger network.

FIG. 5A shows a battery supply embedded inside a bullet head with polarity markings.

FIG. 5B shows a magazine of battery bullets that can be discharged in sequence, depending on application as first in first discharged before being used.

FIG. 6 shows a weapon re-coil energy recovery system to act as a localized energy source.

### DRAWINGS-REFERENCE NUMERALS

2 standardized intelligent modular cell
2A standardized intelligent module main vest cell wired
2B standardized intelligent pocket module cell wirelessly coupled
2C primary controller as standardized intelligent module main vest cell
2D secondary controller as standardized intelligent module main vest cell
4 standard connector and/or wireless or accessory ports
4A blank standard connector socket
4B standard voltage level v1 (example 8 volts) & current level i1 (example 1 amp) socket
4C standard voltage level v2 (example 12 volts) & current level i2 (example 50 milliamps) socket
4D other standard socket
4E platform bus
6 wireless power and data distribution
6A laser or optical power and data distribution
8 global power and data distribution cloud
10 controller or embedded computer system that can have unit identification and configuration data as well as a display
10A primary controller module: can contain unit identification, configuration, sensor, and central supply distribution module
10B backup (secondary) controller module: can contain unit identification, configuration, sensor, and central supply distribution module
12 localized source
14 localized sink
16 localized source distribution, re-sourcing control system and cabling
18 localized health monitor and criticality control system
18A intensity of local source in-flow sensor for localized health monitor
18B voltage, energy, level, volume, pressure, or other local source indication sensor
18C intensity of local sink out-flow sensor for localized health monitor
18D voltage, energy, level, volume, pressure or other local sink indication sensor
18E other sensors
18F data coupling
20 supply (sink and/or source) coupling
20A positive terminal
20B negative terminal
24 start
26 initialize
28 check source status
30 check re-sourcing status
32 check sink usage status
34 run controlled source utilization criticality sequence
36 add/remove/isolate sinks and sources based on health status and criticality
38 transfer and process health data and supplies
40 system shutdown condition check
42 shutdown
100 standard intelligent interconnected modular system
100A standard intelligent interconnected sub-module system as quadrant 1 of vest
100B standard intelligent interconnected sub-module system as quadrant 2 of vest
100C standard intelligent interconnected sub-module system as quadrant 2 of vest
100D standard intelligent interconnected sub-module system as quadrant 4 of vest
100E standard intelligent interconnected module system as dismounted field unit
100EA standard intelligent interconnected module system as dismounted field unit furthest to the East 112
100EB standard intelligent interconnected module system as dismounted field unit 2^{nd} from the East 112
100EC standard intelligent interconnected module system as dismounted field unit 3^{rd} from the East 112
100ED standard intelligent interconnected module system as dismounted field unit 4^{th} from the East 112
100EF standard intelligent interconnected module system as dismounted field unit 4^{th} furthest to the West 114
100F standard intelligent interconnected module system as field supply generator unit
100G standard intelligent interconnected module system as field parachuted supply unit
100H standard intelligent interconnected module system as landed supply unit
100I standard intelligent interconnected module system as deployed solar re-charging station unit
100J standard intelligent interconnected module system laser and/or microwave re-sourcing unit
100K standard intelligent interconnected module system laser and/or microwave receiving unit
100L standard intelligent interconnected module system vehicle
100M standard intelligent interconnected module system land rover vehicle
100N standard intelligent interconnected module system small spy drone vehicle
100O standard intelligent interconnected module system drone vehicle carrying supplies
100P standard intelligent interconnected module system re-supply aircraft
100Q standard intelligent interconnected module system troop transport helicopter
100R standard intelligent interconnected module system submarine
100S standard intelligent interconnected module system Global Hawk/Predator or other drone
100T standard intelligent interconnected module system satellite or space craft
100O standard intelligent interconnected module system ground earth station
100V standard intelligent interconnected module system head quarters
101 region of interest
102 buildings
104 vehicle
106 mountain ranges
108 coastline
110 water
112 East Direction
114 West Direction
200 bullet head, serving as positive terminal of bullet battery
201 bullet battery
202 bullet shell, serving as negative terminal of bullet battery (continuity controlled by 2 in case ammo gets in water etc.)
204 cathode
206 anode
208 current collector
210 separator
212 insulator cap
214 bullet head (negative side)
216 insulator
218 shell space
220 powder
222 permanent magnet breech bolt
224 water proof insulated coil
226 weapon body
228 spring
228A positive plate spring
228B magazine spring
232 negative plate
234 ammunition magazine holding battery bullets
236 ammunition magazine frame
238 to gun chamber
240 magazine spring plate

### DETAILED DESCRIPTION

The present invention is described in part in terms of functional block components and various processing steps. Such functional blocks can be realized by any number of hardware and/or software components configured to perform the specified functions. The invention may be practiced in any number of contexts. The data communication and supply control system described herein is merely one exemplary application of the invention.

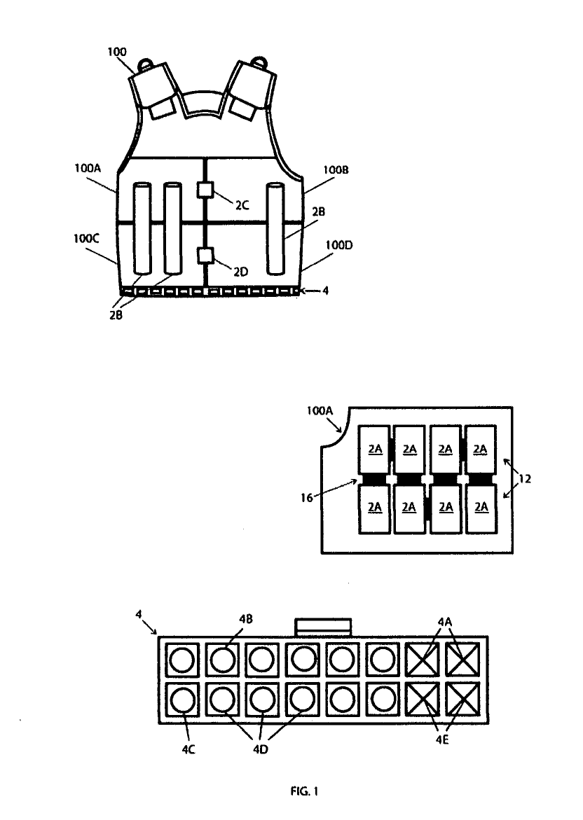

In FIG. 1 an example application of the invention is shown where a standard intelligent interconnected module 100 is shown as a vest with multiple standard intelligent interconnected module quadrants 100A, 100B, 100C, and 100D. The top left quadrant 100A is shown separately with standardized intelligent interconnected modules as wired main vest cells 2A that serve primarily as batteries (sources) as well as wireless pocket cells 2B that primarily serve as loads (sinks). A standardized intelligent modular cell acting as primary controller 2C and backup controller 2D modules are shown as part of the standard intelligent interconnected modular system 100 unit. The controllers 2C and 2D contain identification, configuration, sensor systems, and central supply distribution control to keep track of identification as well as the configuration of the module 100, as well as any supply health sensor information for module 100. Controllers 2C and 2D can be designed such that the internal vest cells 2A are discharged first so that wireless cells 2B can be swapped fully charged between users if needed. The health sensors can include heart rate, blood pressure, temperature, electrocardiogram readings, or other useful readings such as overall supply levels including ammunition, water, food, weapons or other pertinent supplies. Standardized connector socket plug 4 controlled by controllers 10 is shown at the bottom of FIG. 1 with blank standardized connector sockets 4A, for expansion, as well as standardized voltage and current level socket 4B and other standardized voltage and current level socket 4C. Other standard sockets 4D are used for specified voltage settings as adjusted by standardized connector pin plug setting to ground or as desired to provide the voltage and current output to a desired specified standard set level to satisfy heterogeneous equipment power requirements if needed.

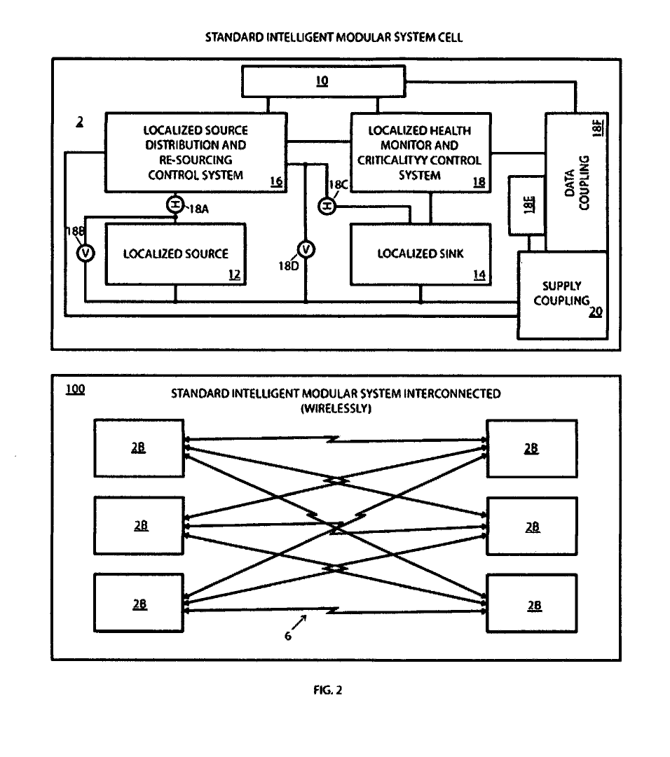

In FIG. 2 a standardized intelligent module cell 2 that forms the basis of the standard intelligent interconnected module 100. Inside the standardized intelligent module cell 2 the localized source 12 is shown of which can be internal and/or external to module cell 2 through wired or wireless supply coupling 20 as a battery, capacitor, power supply, ammunition, fuel source, explosives, canteen, food supply, or any other form of supply that needs to be tightly controlled and managed throughout a mission. Localized source 12 can also be a standard battery case that holds one or more standard size AAA, AA, A, B, C, D or other standard battery sizes, or be a proprietary battery. Localized sink 14 acts as a load as the consumer of the source and/or supply of which can either be internal and/or external to module cell 2 through wired or wireless supply coupling 20.

Localized supply/source and resourcing/re-supplying distribution and control system 16 manages the resourcing/re-supplying of the localized supply/source. The supply management system 16 can limit the supply (current) locally through supply (current) limiters, or can inform or control the sink 14 on consumption flow rates, as well as communicate supply or re-supply requests through health monitor 18 that can route to other system modules 100 through data coupling 18F.

The supply control system 16 uses localized health monitor and criticality control system 18 to manage localized sink 14 consumption and re-supplying of supply 12. The localized health monitor and criticality control system 18 utilizes intensity sensor shown as “I” 18A that measures source supply flows (current) and direction (adding or subtracting), as well as source potential sensor shown as “V” 18B for voltage or supply level or supply deficit. The localized health monitor and criticality control system 18 also uses sink intensity sensor shown as “I” 18C that measures sink supply flows and direction, as well as source potential sensor shown as “V” 18D for voltage or supply level of localized load or sink that consumes the source. The localized health monitor and criticality control system 18 can also use other sensors 18E to make decisions on how to adjust and control supply flows between localized source 12 and sink 14, as well as through external sources through wired or wireless supply coupling 20. If the module is a critical module (Such as “Level A” to use avionics parlance), then the module can use its own localized source 12 last, utilize lower level external sources as much as possible until drained, and then use internal localized source 12. The localized health monitor and criticality control system 18 uses wired and/or wireless data coupling 18F to communicate and route to/from other standard intelligent module cells 2 and/or primary controller 2C and/or secondary controller 2D and between intelligent interconnected module system 100 to module system 100 for communications.

At the bottom half of FIG. 2 is standard intelligent interconnected module 100 with only wireless standard intelligent module cells 2B that are interconnected wirelessly through wireless power and data distribution 6.

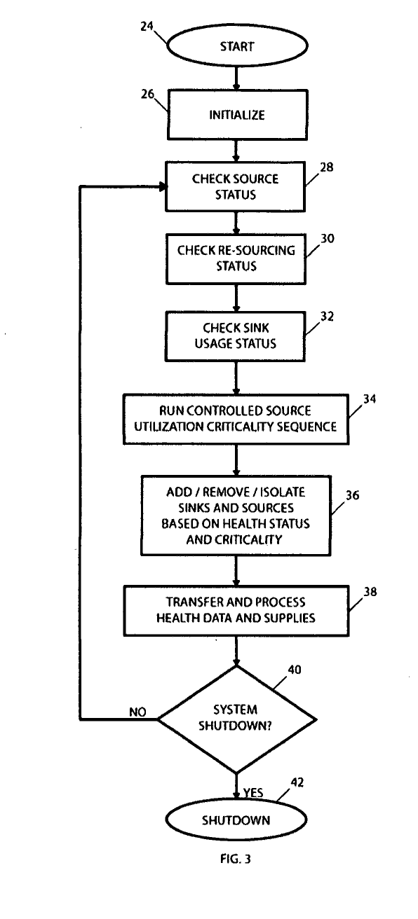

In FIG. 3 the software 10C that runs on the controllers 10 is shown starting at 24, where the control system is initialized at 26 where a check is done on source status 28, as well as a check on re-sourcing status 30. A check on sink usage (consumption) status occurs at 32. Source utilization criticality sequence is executed on process block 34 where at process block 36 the adding, removing, isolating of sinks, and sources based on health status and criticality occur. At process block 38 the prioritized controlled transfer and processing of health data, and supply flows are executed. At decision block 40 the system checks if a manual or automatic shutdown is needed. If no shutdown is needed, process returns flow to check the source status 28 and so on. If a shutdown is needed, the shutdown process occurs at process shutdown 42.

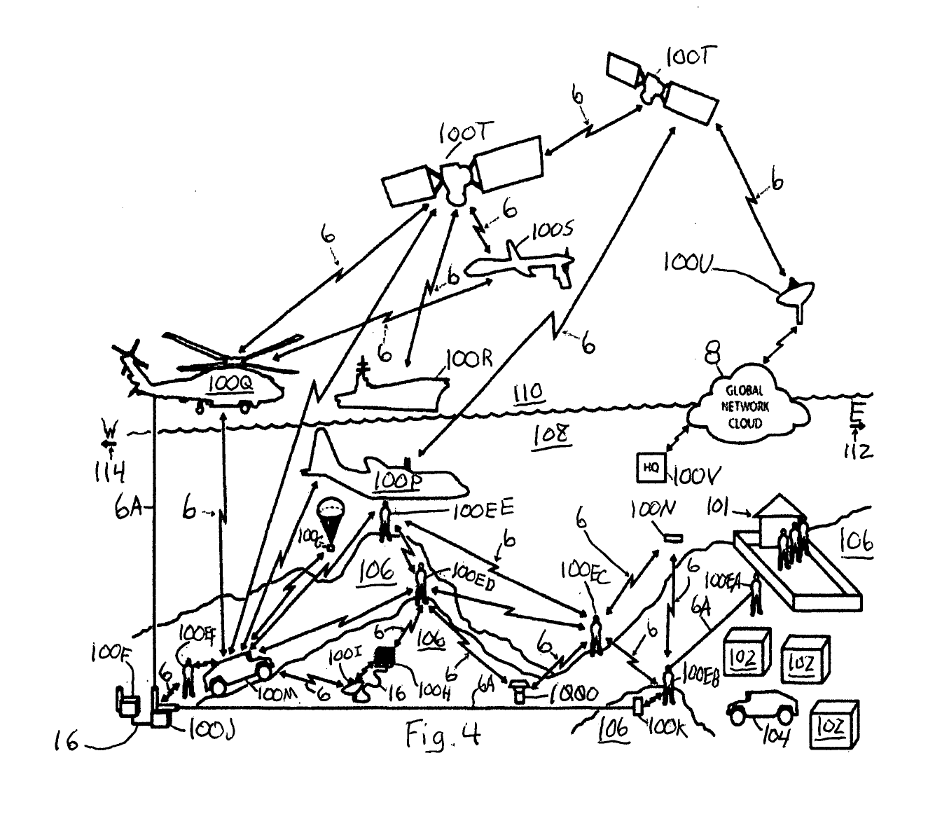

In FIG. 4 a higher context level of all standard intelligent interconnected modules 100 as dismounted field units 100E and other units 100A through 100V how they are coupled through wireless means 6 are shown. Dismounted standard intelligent interconnected module field units 100E are shown in FIG. 4 along mountain terrain surfaces 106 can be connected wirelessly through an ad hoc distributed mesh network of radio waves as wireless signals 6 or optical wireless via laser beams or microwaves as 6A of which, through proper alignment, can be used to transfer energy as well as data to recharge batteries, or to move and communicate in a less detectable manner and still transfer data, and adjust prioritized critical supply flows.

Near region of interest 101, buildings 102, and vehicle 104, a forward dismounted field unit 100EA farthest to the East 112 is interconnected with another nearby dismounted field unit 100EB near dismounted field unit 100EA using automatically tracked and locked laser beam 6A by dismounted unit 100EA to maintain radio silence, but still able to communicate to ad hoc mesh network 6. A third forward dismounted field unit 100EC communicates with dismounted forward unit 100EB through radio signal 6 to 100EC where radio signal 6 is purposely out of range of forward dismounted field unit 100EA to maintain radio silence.

Forward operating spy drone 100N is controlled and communicated by dismounted field unit's 100EC or 100EB using wireless signal 6, or if desired, using an automatically tracked and locked laser beam 6A not shown as substitute to wireless radio signal 6. Forward operating semi-autonomous supply drone 100O is shown bringing supplies to, and communicating via wireless signal 6 with forward operating unit 100EC. Drone 100O can be designed to operate just a few feet above terrain to avoid detection and autonomously or semi-autonomously move dismounted needed supplies between forward operating units 100E and local supply source 100H being resupplied by solar charging unit 100I through localized source distribution and re-sourcing control system cabling 16 if supplies are rechargeable batteries, or elsewhere for other needed supplies. Forward operating unit 100EC is shown in wireless radio signal 6 ranges of forward operating units 100EE and 100ED that are further to the West direction 114. Status data of forward supply source 100H is obtained through forward unit 100ED as well as through forward operating land rover unit 100M through wireless signals 6. Status of forward dismounted units 100EA, 100EB, 100EC, and 100ED is communicated wirelessly via wireless signals 6 through forward operating land rover unit 100M and forward operating dismounted support unit 100EF.

Fast forward remote unit battery charging is shown between laser receiving and battery charging unit 100K and laser re-sourcing unit 100I using laser beam 6A where laser re-sourcing unit 100J is powered by generator unit 100F through localized source distribution and re-sourcing control system cable 16. Laser charging unit 100J can be controlled and monitored by dismounted unit 100EF through wireless signal 6.

Laser re-sourcing unit 100J can be designed to optically communicate to helicopter 100Q via autonomously tracking laser beam 6A to maintain radio silence, or alternatively using wireless signal 6 when radio silence is not needed.

Land rover vehicle 100M can communicate wirelessly to helicopter 100Q, supply aircraft 100P, parachuted supply 100G, as well as forward operating dismounted units 100EE, 100ED, and solar re-charging supply unit 100I using wireless signals 6.

Helicopter 100Q can communicate with satellite 100T, high altitude drone 100S via wireless means 6, whereby satellite can communicate to aircraft carrier 100R or other ship in water 110 near shore 108, as well as to and from high altitude drone 100S also through wireless means 6.

Satellite 100T can communicate via wireless means 6 to and from a command and control headquarters 100V through other satellites 100T and ground earth station 100U to global network cloud 8.

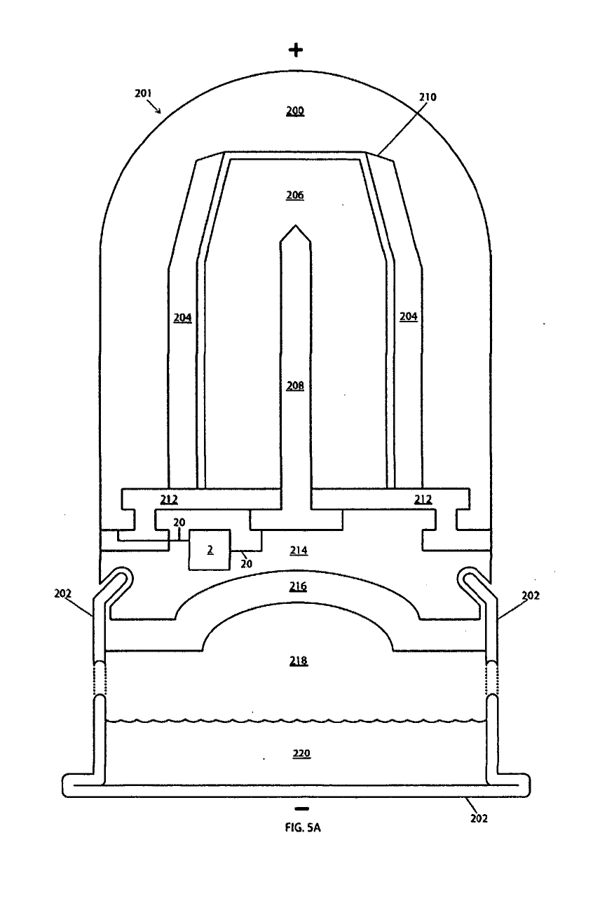

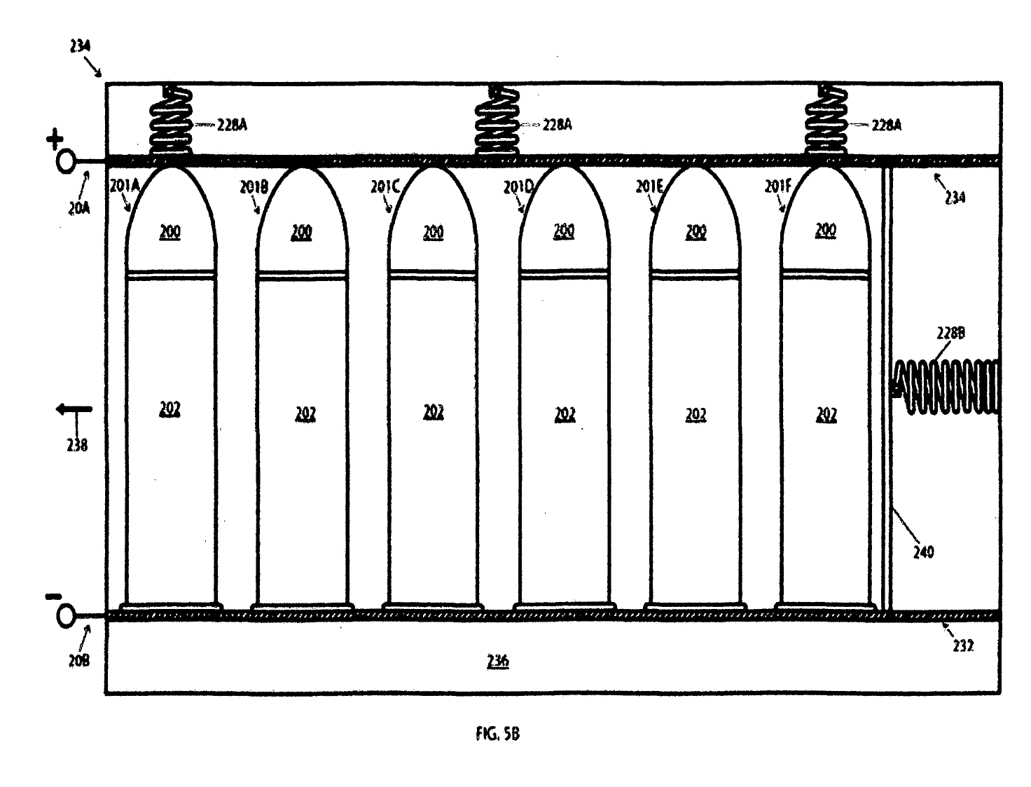

In FIG. 5A, a further embodiment with an emphasis on dismounted field unit weight reduction, a standardized intelligent module cell 2 is shown embedded inside a bullet 201 where the bullet head serves a dual purpose as both projectile and battery where standardized intelligent module cell 2 is coupled with battery through conductors 20. The battery can be manufactured inside the bullet 201 by drilling/boring or forging out the bullet head so that space can be made for the battery parts and/or other materials while maintaining enough structural volume for structural integrity for the bullet to remain intact after impact. The embedded battery contains conductive positive terminal 200, with separator 204, anode 206, current collector 208, and insulator cap 212. Bullet 201 can be designed sturdy enough to stay intact upon impact of a hard surface to minimize fragments, and/or be further enhanced so that the mode of the bullet function can be changed electronically and or electro-mechanically, such as to track a target if hit, using active or in-active (passive) radio frequency identification tags inside 2, or to make the bullet more lethal with one shot by exploding inside the target by mixing cesium and water upon impact. This can be done by using similar technology used in triggering air bag deployment or by impact triggering a charge to break a separator that mixes the substances to produce an explosion.

Bullet head 200 is held together with insulator cap 212 with bullet head negative end 214. Current flow between current collector 208 and bullet head negative end 214 is controlled by standardized intelligent module cell 2 enabling it to switch current on and off to control discharge, as well as re-charge sequence order, such as first in first out in magazine order. Explosive electrical isolator 216 is shown to prevent unintentional triggering of gun powder 220 due to electrical spark between bullet shell 202 serving as negative terminal of the bullet battery and bullet head 214 in air gap 218. Communications from modular cell 2 in bullet 201 to/from modular cellular system 100 of FIG. 1 primary controller 2C can be established by modulating positive terminal 200 and/or negative terminal 202 using supply lines 20 thereby combining supply coupling 20 with data coupling 18F. This same combination of coupling can be used in other applications of modular cell 2.

FIG. 5B shows battery bullets 201A, 201B, 201C, 201D, 201E, 201F inside an ammunition magazine 234 with positive terminal plate 234 held by springs 228A and moved by magazine spring 228B that holds plate 240. The bullet batteries are discharged in sequence of first in first out in magazine order, so that the bullet batteries first to arrive in the chamber are significantly discharged unless set to track using active radio frequency identification tags.

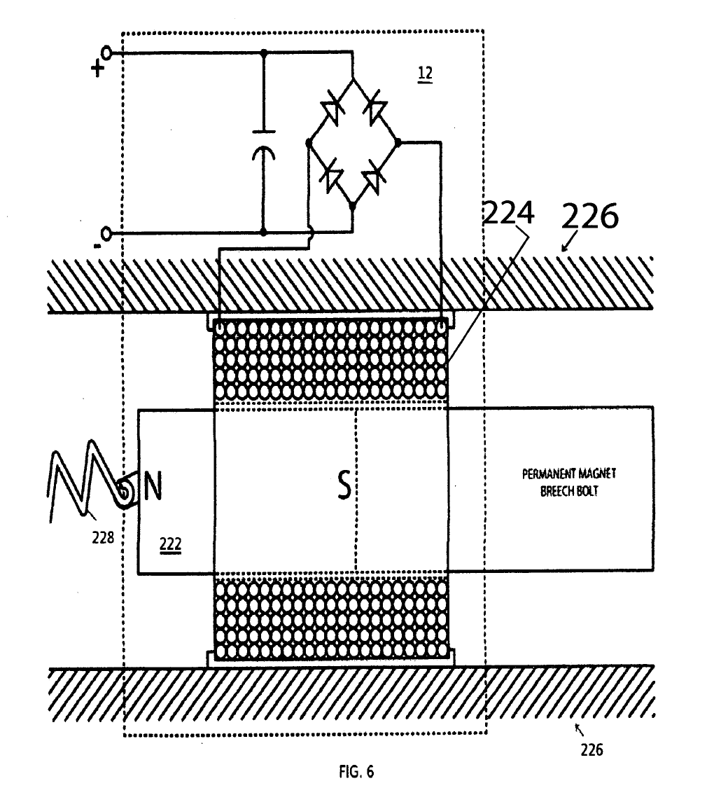

FIG. 6 shows a charging system utilizing kick back from a weapon breech bolt using a permanent magnet 222 connected to a spring 228 inside a barrel 226 inducing current into coil 224 when the weapon is fired. Alternating current flows in coil 224 through bridge rectifier and charges capacitor and batteries or provides power to other equipment. Kick back energy can be transferred to other coils, and/or a flywheel connected to a generator, such as to a flywheel with a crank shaft to operate much like a piston in an engine but mechanically designed to drive the flywheel only during the re-coil operation (like a pull line on a lawn mower allowing the flywheel to spin freely from the breech bolt 222. The inertial energy from the flywheel can also serve to stabilize the aim of a weapon through gyroscopic action.

The idea of gyroscopic power generation can be expanded to an exoskeleton joint energy capture system of field personal and can also be included into gyroscopic power generation of shock absorption from footsteps, as well as to body surface compression spaces such as from sitting or from touching a surface of which would otherwise be converted to heat energy, but is converted to potential electrical energy instead.

Operation

The main operation of all the embodiments is efficient and prioritized utilization of all standardized intelligent modular cells 2 that are building blocks of the standard intelligent interconnected modular system 100 so that they can all function interchangeably and seamlessly together towards a common goal of efficiently managing supplies and feeding, as well as generating and moving supplies to critical operations in the field. Part of the efficiency improvement is allowing field operators to do more operational activities with less weight by sharing standardized intelligent modular cells 2.

Standardization is achieved by having an established standard connector 4 that can be a connector of any type, so long as it is standardized for access by all intelligent standard wired module types 2A, in a similar manner as a standard 12 volt cigarette lighter connector is to an automobile, or a 120 volt alternating current outlet is to a home as a standard plug and socket configuration in North America. The voltage levels on connector 4 can be one or a set of any established levels and can be adjustable by pin setting or otherwise, so long as they are set to standard levels that all standard wired module types 2A are able to set and function as desired and are recognized. For wirelessly connected standardized intelligent module cells 2B the wireless behavior of communications and energy transfer can be established in numerous ways, such as a standard geometry charging surface in a similar manner as a standard electric toothbrush and toothbrush holder.

Each standardized intelligent modular system 100 has at least one standard intelligent module cell 2 operating as primary controller 2C, and one or more designated as backup controller 2D to immediately be able to take over if primary controller 2C fails. If primary controller 2C fails, then the backup controller 2D or other backup controller 2D operates as a new primary controller 2C replacing the failed primary controller 2C. A new working backup controller 2D is then established, in case the new primary controller 2C fails, and so on, until all available controllers on intelligent modular system 100 are consumed. Control transfer can be done using status messages between all standard intelligent modular cells 2 inside standard intelligent interconnected modular system 100. Messages between internal standard intelligent modular cells 2 and external systems can be routed through primary controller cell 2C or through another cell 2 that the primary controller 2 identifies and designates as a communication module cell 2.

Communications between cells 2 can be of any standard; so long as all cells 2 use that same standard. One ubiquitous communications standard commonly used at the time of the invention is Ethernet and wireless Ethernet standards established by the Institute of Electrical and Electronics Engineers (IEEE). If wireless communications is desired in operation modes where radio silence is essential, such as when using jammers to prevent improvised explosive devices (IED's) from triggering, optical communications 6A as part of data coupling 18F can be used inside and between wireless cells 2B while laser communications 6A can be used between standard intelligent modular cell system 100 through an established standard intelligent wireless module cell 2B designated for external laser communications.

As provided in FIG. 2 inside the standard intelligent modular cell 2 there is a localized sink 14 that acts as a load or consumer of supplies whether it be energy, or water, it represents consumption where supplies drain to from source 12 or external source 12 through supply coupling 20. The status of sink 14 and source 12 behavior is determined by voltage (or volume or other) sensor 18D and 18B as well as through flow intensity sensor 18C and 18A. Accurate predictions on when sink 14 will deplete source 12 can be made and provided by these sensor readings and processing from the localized health monitor and criticality control system 18. The predictions can also limit, increase, decrease, shut off, turn on, or adjust flows from localized source 12 and other supply sources through supply coupling 20 using flow (or current) limiters established inside localized source distribution and re-sourcing control system 16. These predictions can also provide automatic or manual requests out through data coupling 18F to rapidly order new supplies out to the field of which can be routed and exchanged between standard intelligent modular systems 100. Manual supply and flow control requests can be executed through unit identification, configuration, and control computer module 10 of which can control localized sink 14 and localized source 12 supply flows through localized source distribution and re-sourcing control system 16 for local flows, or for the entire standard intelligent interconnected modular system 100 through data coupling 18F using a communication modular cell 2B to other modular systems 100 routed all the way to supply source using supply routing path tables that are continually updated based on supply status where a supply transfer process can begin and be tracked.

Health information can be formatted in any standard format so long as all intelligent standardized cells 2 can understand the format. One example is to use eXtensible Markup Language (XML) to format the messages where the data can be compressed and encrypted for transfer where it is decompressed and decrypted at the other end. An example of one message in XML is what follows. This is merely an example of just one message type, and there are many different types of messages that can be transferred as well as many possible different types of data that can be shared and optimized between individual cells 2 and intelligent modular systems 100 such as supply ordering messages, region status messages, broadcast messages, and many other types of messages for hierarchal or flat, or other structure of command, control, and supply routing optimization, automation, and monitoring. Other data can be shared between modules, such as position, temperature, or position of something of interest, or any other useful data.

<ModularCellSystemHealthMessage>

<NumOfOnboardUsers>1</NumOfOnboardUsers>
<NumOfModulesOnboard>37</NumModulesOnboard>
<UserStatus>

<UserID>8675309</UserID>
<Vitals>

<HeartRate>60 BPM</HeartRate>
<BloodPressure>120/80 mmHg</BloodPressure>
<BodyTemperature>98.9F</BodyTemperature>
<FatigueLevel>5</FatigueLevel>

</Vitals>
<EnvironmentTemperature>120F</EnvironmentTemperature>
<Humidity>98%</Humidity>
<UserPersonalSupplyStatus>

<water>

<Volume>3 liters</Volume>
<AvgUsageRate>1 liter/hour</AvgUsageRate>
<EstRemainingTime>2 hours</EstRemainingTime>

</water>
<food>

<Volume>3 units</Volume>
<AvgUsageRate>0.25 units/hour</AvgUsageRate>
<EstRemainingTime>24 hours</EstRemainingTime>

</food>

</UserPersonalSupplyStatus>

</UserStatus>
<MainBatteryStatus>

<NumMainBatteries>32</NumMainBatteries>
<NumMainFunctionalBatts>31</NumMainFunctionalBatts>
<TotalAmpHoursRemaining>346</TotalAmpHoursRemaining>
<AvgEnergyUsageWatts>15</AvgEnergyUsageWatts>
<PeakEnergyUsageWatts>25</PeakEnergyUsageWatts>

</MainBatteryStatus>
<WeaponStatus>

<NumOfWeapons>1</NumOfWeapons>
<Weapon>

<WeaponType>M16</WeaponType>
<AmmunitionType>35 mm battery
cells</AmmunitionType>
<AmmunitionQuantity>204</AmmunitionQuantity>
<AmmoAvailAmpHours>252</AmmoAvailAmpHours>
<AverageAmmoUsage>10/hour</AverageAmmoUsage>
<PeakAmmoUsage>5/hour</PeakAmmoUsage>

<Weapon>

</WeaponStatus>

</ ModularCellSystemHealthMessage >

What is claimed is:

1. A wearable power grid comprising a garment, said garment having at least one switch, a power system having means to receive power from standardized modular power means, and a data storage system; said power system monitoring the health and supply status of said data storage system; said power system controlling the health and supply status of said data storage system; and said power system powering the health and supply status of said data storage system.
